(19) United States
(12) Patent Application Publication
(10) Pub. No.: US 2025/0377644 A1
(43) Pub. Date: Dec. 11, 2025

(54) COMPUTATION SYSTEM

(71) Applicant: TOYOTA JIDOSHA KABUSHIKI KAISHA, Toyota-shi Aichi-ken (JP)

(72) Inventors: Ryohei OURA, Nagoya-shi Aichi-ken (JP); Yuji ITO, Nagakute-shi Aichi-ken (JP)

(73) Assignee: TOYOTA JIDOSHA KABUSHIKI KAISHA, Toyota-shi Aichi-ken (JP)

(21) Appl. No.: 19/223,984

(22) Filed: May 30, 2025

(30) Foreign Application Priority Data
Jun. 5, 2024 (JP) 2024-091649

(51) Int. Cl. G05B 17/02

(52) U.S. Cl. CPC G05B 17/02

(57) ABSTRACT

In a computation system for calculating a probability distribution of an output of control for each input condition in control of an object, the computation system according to the present disclosure is configured to perform calculation of the probability distribution of the output of the control performed by calculating certainty of probability for each probability distribution interval and correcting the probability for each interval according to a degree of certainty of the probability. In this correction, the probability distribution of the output of control is calculated by correcting the probability for each interval so that a probability reduction rate when the certainty of probability is less than a predetermined value is larger than a probability reduction rate when the certainty of probability is higher than a predetermined value.

### CROSS REFERENCE TO RELATED APPLICATIONS

This application is based upon and claims the benefit of priority from Japanese patent application No. 2024-091649, filed on Jun. 5, 2024, the disclosure of which is incorporated herein in its entirety by reference.

### BACKGROUND

The present disclosure relates to a computation system.

Patent Literature 1 discloses a system that can evaluate the output results of commands for causing an object to take an action (perform control of an object) using probability distribution. More specifically, the result of image recognition around an object (mobile object) is applied to the Bayesian model to calculate the output evaluation (degree of confidence) of each command to be executed on the object.
Patent Literature 1: Japanese Patent No. 4159794
Non-Patent Literature 1: Anastasia Makarova, et. al., Risk-averse Heteroscedastic Bayesian Optimization, NeurIPS 2021
Non-Patent Literature 2: Dimitrios Milios, et. al., Dirichlet-based Gaussian Processes for Large-scale Calibrated Classification, NeurIPS 2018
Non-Patent Literature 3: Bertrand Charpentier, et al. al., Posterior Network: Uncertainty Estimation without OOD Samples via Density-Based Pseudo-Counts, NeurIPS 2020

### SUMMARY

The aim of the present disclosure is to realize a system by which the probability distribution of the output of control of an object for each input condition and its reliability can be easily grasped in a set.

The present disclosure has been made to solve the aforementioned problem, and provides a computation system or the like by which the probability distribution of the output of control of an object for each input condition and its reliability can be easily grasped in a set.

According to the present disclosure, in a computation system for calculating a probability distribution of an output of control for each input condition in control of an object, calculation of the probability distribution of the output control is performed by calculating certainty of probability for each probability distribution interval and correcting the probability for each interval according to a degree of certainty of the probability.

According to the present disclosure, it is possible to provide a computation system by which the probability distribution of the output of control of an object for each input condition and its reliability can be easily grasped in a set.

The above and other objects, features and advantages of the present disclosure will become more fully understood from the detailed description given hereinbelow and the accompanying drawings.

### BRIEF DESCRIPTION OF DRAWINGS

FIG. 1 is a block diagram illustrating a configuration of a computation system according to the present disclosure;

FIG. 2 is a diagram illustrating a computation method according to the present disclosure;

FIG. 3 is a diagram illustrating a robot simulation and output labeling;

FIG. 4 is a diagram illustrating generation of a probability density function and learning of posterior probability density; and

FIG. 5 is a block diagram showing an example of a hardware configuration of a computation system.

### DESCRIPTION OF EMBODIMENTS

In the development of a system that behaves in a stochastic and complex manner such as a robotic transport system, it is important to verify and analyze the task achievement for each input condition from data. However, in reality, it is difficult to collect a large amount of robot trajectory test and actual machine data under various input conditions. On the other hand, it is required to calculate a probability distribution and evaluate the task achievement while considering complex system noise and tasks. Moreover, such a robotic transport system is often safety-critical, and it is necessary to properly quantify the uncertainty of the distribution calculation result. Therefore, the present disclosure proposes a method by which noise and task complexity can be dealt with even with a small data volume, and overconfidence in probability estimation can be suppressed.

Specifically, in the present disclosure, output values are discretely labeled, the pseudo data count number of each label at any value of input conditions is estimated from the modeled data, and a discrete distribution for the label is estimated based on the estimated pseudo data count number. Thus, a method for suppressing overconfidence in the estimation is proposed.

In one embodiment, in a computation system for calculating a probability distribution (e.g., the estimated travel time distribution to reach the destination) of the control output for each input condition (e.g., the initial position) in control of an object, calculation of the certainty of probability is performed by calculating certainty of probability (e.g., dispersion) for each probability distribution interval (e.g, per label) and correcting the probability for each interval according to a degree of certainty of the probability.

In the correction, the probability distribution can be calculated by correcting the probability for each interval so that a probability reduction rate when the certainty of probability is less than a predetermined value (e.g., the variance is greater than or equal to a predetermined value) is larger than a probability reduction rate when the certainty of probability is higher than a predetermined value (e.g., the variance is less than a predetermined value).

The probability distribution is calculated by correcting a count number of the control for each control input condition according to certainty of the probability and correcting the probability for each interval according to the amount of the corrected count number (pseudo-count number). More specifically, in this correction, the corrected count number (pseudo-count number) is calculated by correcting the count number for each of the above input conditions (e.g., initial position) so that the reduction ratio of the count number is larger when the certainty is lower than a predetermined value (e.g., variance is greater than or equal to a predetermined value) than when it is not. The probability distribution based on certainty is then calculated by updating the probability distribution based on the calculated corrected count numbers (pseudo-count numbers). Thus, reliability of the interval where the count number in the probability distribution is small can be easily grasped.

The probability distribution is obtained by Bayesian inference, and the probability distribution as a prior distribution is updated to a posterior distribution each time as the number of control count numbers for each control input condition increases. In one embodiment, the control of an object is the control of traveling of a mobile object.

An embodiment of the present disclosure will be described below with reference to the drawings. The following description and drawings are omitted and simplified as appropriate for the sake of clarification of the description.

The present disclosure proposes a Bayesian model and its estimation method for estimating the probability distribution at each input of discretely labeled output given the input and output data and suppressing overconfidence in the estimation.

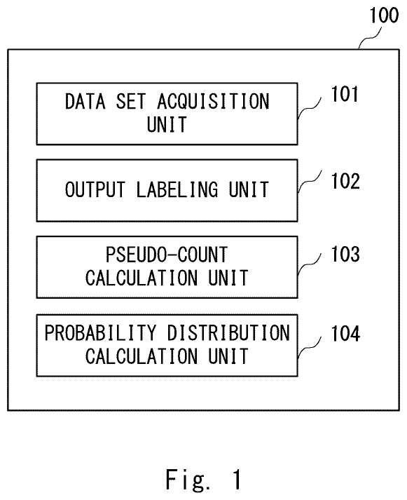

The configuration of a computation system according to the present disclosure will be described with reference to FIG. 1.

FIG. 1 is a block diagram for describing a configuration of a computation system according to the present disclosure.

A computation system 100 can be implemented by one or more computers having processors, memories, and the like. The computation system 100 includes a data set acquisition unit 101, an output labeling unit 102, a pseudo-count calculation unit 103, and a probability distribution calculation unit 104.

The data set acquisition unit 101 acquires an input and output data set. The output may be continuous or discrete in advance.

The output labeling unit 102 labels the output of continuous values discretely. In the case of a robot system, such as output trajectory, time series clustering or evaluation values by STL (Signal Temporal Logic) can be used.

The pseudo-count calculation unit 103 performs modeling and learning of the pseudo-count number of the labeled output at any input value based on non-parametric Bayes. Then, the pseudo-count calculation unit 103 conservatively calculates the pseudo-count number with a predetermined parameter.

The probability distribution calculation unit 104 calculates the probability distribution of the labeled output from the pseudo-count number at any input value. A degree of confidence calculation unit for calculating degree of confidence for the calculated probability distribution may be further provided.

Here, the Non-Patent Literatures 1 to 3 and their problems will be explained.

In Non-Patent Literature 1, the relationship between the input x and the output y is given by the following Formula using the dynamics f and the noise term ε. In this case, the noise term follows a certain distribution, and its variance depends on the input.

$$y = f ( x ) + ϵ ( x ) , ϵ \sim 𝒩 ( 0 , {σ}^{2} ( x ) ) . \qquad [ Formula 1 ]$$

New data is predicted by regressing both f and σ² from data by Gaussian process. Assume that the distribution of the noise term has sub-Gaussian property. Sub-Gaussian property refers to a property in which the tail of the distribution is equivalent to the Gaussian distribution (i.e., the normal distribution).

Non-Patent Literature 1 cannot be applied to the case where the shape of the probability distribution that the output value follows for each input is complicated (for example, a multi-peak probability distribution or a heavy-tailed probability distribution). As an example, a case where it is applied to the data of the initial position x of the robot and the time required to reach the goal y is examined. The robot is affected by the internal stochastic algorithm, the placement of obstacles, the road conditions, etc., and takes a different path for each data even when the initial position is the same. At this time, for example, in the case where the route is divided into three major ways, the distribution of the final arrival time has at least three peaks, so that the output (the arrival time) has a multi-modal probability distribution for each initial position. Therefore, in the case of the robot described above, Non-Patent Literature 1 cannot be applied.

Therefore, owing to the provision of the output labeling unit 102 in the computation system 100, such complicated probability distribution can be dealt with by the computation system 100. In particular, in the case of the output trajectory of the robot system, the output labeling unit 102 can use evaluation values by time-series clustering or STL (Signal Temporal Logic).

In Non-Patent Literature 2, occurrence probability vector of output label l under any input x is estimated from the input data and the label data. The probability vector of the label under each input is modeled by a discrete distribution model and a Gaussian process that generates its parameters as a function.

$$l \sim p ( l \vert f ( x ) ) , f \sim GP . \qquad [ Formula 2 ]$$

The desired occurrence probability vector is obtained by regressing f from the data. The degree of confidence in the estimation depends only on the uncertainty of the Gaussian process after the regression.

According to Non-Patent Literature 2, the degree of confidence for probability estimation is determined only by the uncertainty of the Gaussian process. It is not always possible to correctly reflect the number of observations and the bias of the output data at each input, and overconfidence in the estimation often occurs. Therefore, it may not be directly applicable to estimation for safety-critical systems.

Therefore, the computation system 100 described above is provided with the pseudo-count calculation unit 103 configured to perform modeling and learning by non-parametric Bayes of the pseudo-count number of labeled outputs and conservatively calculate the pseudo-count number with the predetermined parameters. Thus, it can be adapted to estimation for safety-critical systems.

In Non-patent Literature 3, occurrence probability vector p(l|x) of output label l under any input x is estimated from the input data and the label data. The probability vector of the label under each input is considered to be generated from the Dirichlet distribution, and the parameters of the Dirichlet distribution are expressed and modeled based on a neural network.

$$p ( l \vert x ) \sim Dir ( \cdot \vert α ( x ) ) \qquad [ Formula 3 ]$$

The desired occurrence probability vector p (l|x) is obtained by learning from the data. Intuitively speaking, α (x) represents “the number of pseudo data obtained at the input point x”. The degree of confidence in the estimation depends on the uncertainty of the Dirichlet distribution Dir (⋅|α (x)). The smaller α is, the more uncertain the degree of confidence in the estimation is.

However, in Non-Patent Literature 3, the uncertainty of the estimation result of the pseudo-count itself cannot be reflected. Therefore, the estimation of the pseudo-count in the case of a small data volume may become unstable, thereby causing overconfidence in the estimation and deterioration in the accuracy of estimated probability.

Therefore, the computation system 100 described above is provided with the pseudo-count calculation unit 103 configured to perform modeling and learning by non-parametric Bayes of the pseudo-count number of labeled outputs and conservatively calculate the pseudo-count number with the predetermined parameters. Thus, the uncertainty of the estimation result of the pseudo-count itself can be reflected, preventing overconfidence in the estimation and improving the accuracy of the estimated probability.

The action and effect of the above-mentioned computation system will be explained.

In the development of a system that behaves in a stochastic and complex manner such as a robotic transport system, it is important to verify and analyze, from the data, the task achievement for each input condition. However, in reality, it is difficult to collect a large amount of robot trajectory test/actual machine data under various input conditions. Therefore, it is difficult to obtain a large number of evaluation values of task achievement and trajectory types as output for each input.

On the other hand, there are many cases in which it is required to calculate the probability distribution of output for each input while taking into account complex system noise and tasks, and to perform evaluation. Furthermore, such systems are often safety-critical, and it is necessary to properly quantify the uncertainty of the distribution calculation results.

Therefore, the present disclosure proposes a method of estimating the probability distribution of output for each input with high accuracy while quantifying the degree of confidence in the estimation while explicitly suppressing the overestimation, even when the input and output data are small in a system with complex noise and tasks.

According to computation system described above, it can support decision-making such as identification of low-performance input regions, acquisition of additional data, and system operation/correction judgment by the stochastic evaluation and degree of confidence quantification of the target system when a small data volume is used.

In addition, the initial evaluation of the low-performance inputs when a small data volume is used and the judgment of inputs for which additional data should be acquired can be supported by the estimation of the probability distribution of output values at any input and the quantification of the degree of confidence.

Furthermore, safe decision making based on conservative calculation of uncertainty of estimation can be supported in cases where generation of the system trajectory data is of high cost and therefore should be performed carefully, such as in robot systems coexisting with humans. For example, operation decision making based on probability of proximity to humans in a specific area and its estimated degree of confidence for each initial speed and initial position can be supported. Since estimation is automated, it can be performed by anyone with data.

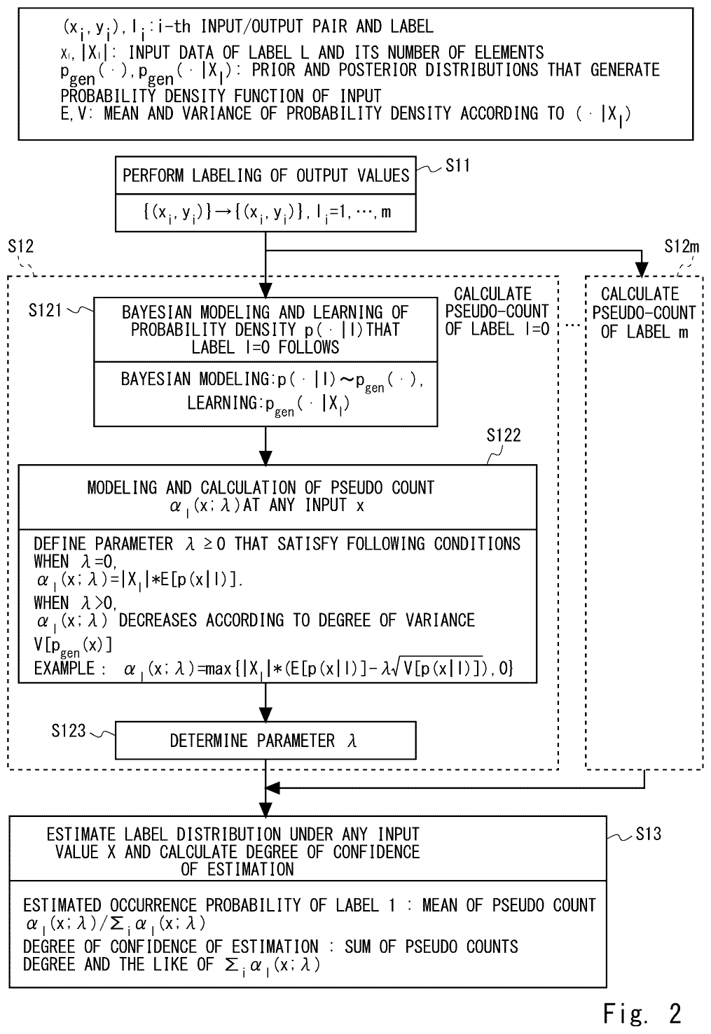

FIG. 2 is a diagram illustrating the calculation method according to the present disclosure.

Specifically, the probability distribution estimation of an evaluation value of request achievement for each initial position by robot simulation and quantification of estimation uncertainty will be described.
(xᵢ, yᵢ): i-th input/output pair
(xᵢ, yᵢ), lᵢ: i-th input/output pair and label
X₁, |X₁|: input data of label l and its number of elements
p_{gen} (⋅), p_{gen} (⋅|X₁): the prior and posterior distributions that generate probability density function of the input
E, V: the mean and variance of probability density according to p_{gen} (⋅|X₁)

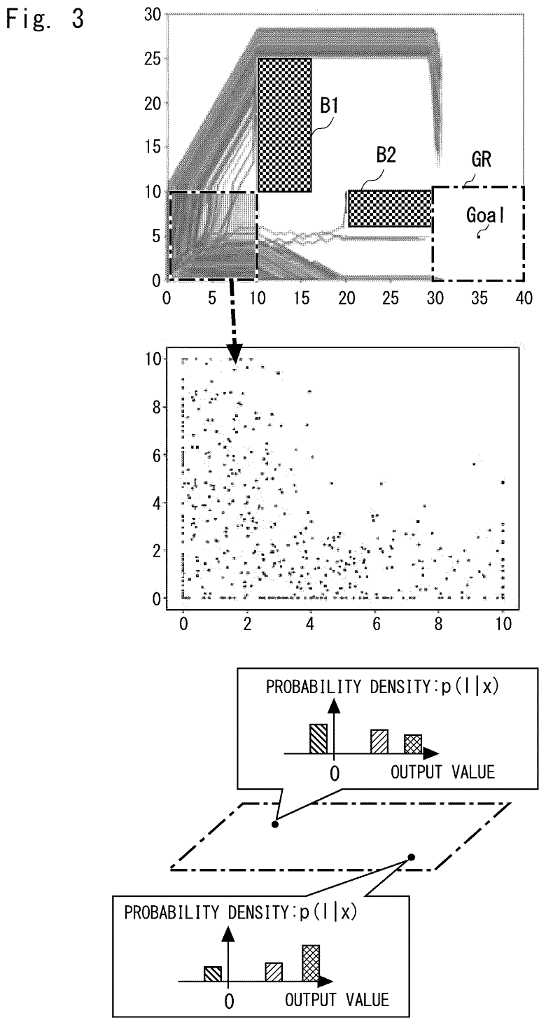

FIG. 3 is a diagram illustrating a robot simulation and output labeling. The top diagram in FIG. 3 shows an environment with two obstacles B1 and B2. Test region X=[0,10]² is given as a set of initial starting positions of the robot. That is, the robot starts traveling from any position of the test region X. An infinite number of elements (e.g., (1, 2), (2.5, 3.2), etc.) can be considered for any position of the test region X. The goal position of the mobile robot is given by (35, 5). The region surrounding this goal position is referred to as a goal region GR. The middle diagram in FIG. 3 shows 500 inputs in the test region X, the inputs being sampled by (18).

$$\begin{matrix}x = ( min \{ max \{ 0 , {x}_{1}^{′} \} , 10 \} ) , \\ {x}^{′} \sim 0.5 𝒩 ( {( 1 , 5 )}^{T} , diag ( 2 , 10 ) ) + 0.5 𝒩 ( {( 5 , 1 )}^{T} , diag ( 10 , 2 ) ) .\end{matrix} \qquad ( 18 )$$

The data set acquisition unit 101 acquires, by simulation, 500 pieces of data consisting of initial position (input) and trajectory data in which the robot travels toward the goal region GR while avoiding obstacles. The data set acquisition unit 101 acquires an evaluation value (output) for the request “to reach the goal within seconds without colliding with the two obstacles”. For details, see, Ryohei Oura and Yuji Ito, Dirichlet Logistic Gaussian Process for Evaluation of Black-Box Stochastic Systems under Complex Specifications.

As shown in FIG. 3, the output labeling unit 102 discretizes and labels the evaluation value (S11).

$$\{ ( {x}_{i} , {y}_{i} ) \} \to \{ ( {x}_{i} , {l}_{i} ) \} , {l}_{i} = 1 , … , m \qquad [ Formula 4 ]$$

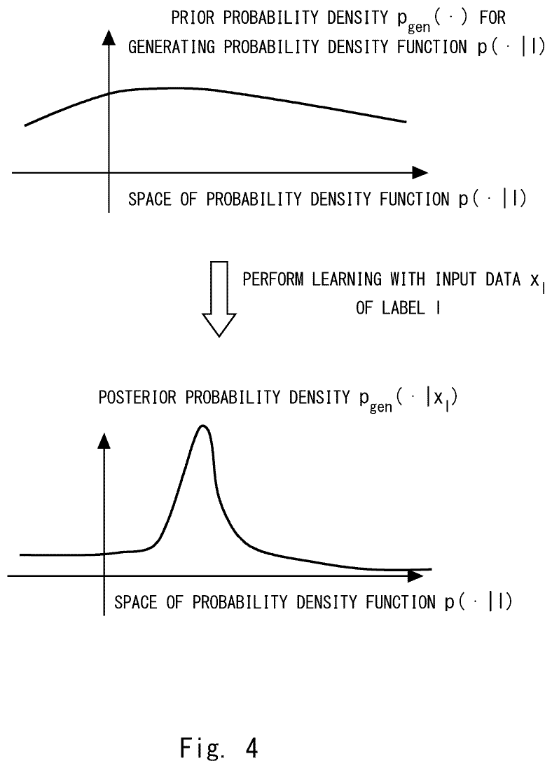

Next, the pseudo-count number of the label l=0 is calculated (S12). FIG. 4 is a diagram illustrating generation of a probability density function and learning of a posterior probability density. First, the generated probability density p (⋅|l) of the initial position under the label l=0 is Bayesian modeled by the logistic Gaussian process p_{gen} (⋅) (S121).

$$p ( \cdot \vert l ) \sim {p}_{gen} ( \cdot ) . \qquad [ Formula 5 ]$$

Note that the Bayesian model in the pseudo-count calculation unit 103 uses a logistic Gaussian process, but it is not limited to this, and various probability distribution models (for example, a Dirichlet process mixing model) for generating probability density function can be used. Further, any various methods (for example, discrete approximation of the input space and Markov chain Monte Carlo, as well as discrete approximation of the input space and Laplace approximation) can be used for learning the posterior distribution.

The posterior distribution p_{gen} (⋅|X₁) of p_{gen} (⋅) is learned from the initial position data X₁ of label l=0 (S121). Similarly, probability density function under label l=1, . . . , m is generated, and the posterior distribution is learned (S12m).

At any initial position, the pseudo data count α₁ (x; λ) of label l deemed to be acquired is modeled (S122). Parameter λ≥0 that satisfy the following conditions is defined.

When λ=0, the pseudo data count α₁ (x; λ) is given by the following Formula:

$${α}_{l} ( x ; λ ) = \vert {X}_{l} \vert * 𝔼 [ p ( x \vert l ) ] . \vert \qquad [ Formula 6 ]$$

wherein when λ>0,
the number of pseudo data count numbers (also called pseudo-counts) α₁ (x; λ) decreases according to the degree of the variance V [p_{gen} (x)], which is certainty of the probability becomes smaller.

$${α}_{l} ( x ; λ ) = \{ \vert {X}_{l} \vert * ( 𝔼 [ p ( x \vert l ) ] - λ \sqrt{𝕍 [ p ( x \vert l ) ]} ) , 0 \} \qquad [ Formula 7 ]$$

Here, E and V represent the mean and variance of p (x|l) to p_{gen} (⋅|X₁) at x, and |X₁ | represents the number of elements of X₁.

The pseudo-count parameter λ≥0 is determined with a predetermined value (S123), and the pseudo-count α₁ (x; λ) is calculated (S12). Similarly, the pseudo-count under the label l=1, . . . , m is calculated (S12m).

The pseudo-count expression in the pseudo-count calculation unit 103 has the following structure.

$${α}_{l} ( x ; λ ) = max \{ \vert {X}_{l} \vert * ( Med [ p ( x \vert l ) ] - λ * g ( \sqrt{𝕍 [ p ( x \vert l ) ]} ) , ) 0 \} \qquad [ Formula 8 ]$$

wherein Med is the median value of p (x|l) to p_{gen} (⋅|X₁) and g(x) is a nonlinear function where g(0)=0.

The parameter A related to pseudo-counts varies depending on the application. Various methods can be used to determine the parameter λ related to pseudo-counts. In addition to the predetermined method, MAP estimation shown below, in which statistical determination is performed according to the data volume, may be used.

$$λ * ∈ arg {max}_{λ \geq 0} {\prod }_{l ∈ L} \frac{{α}_{l} ( x ; λ ) ,}{{\sum }_{i = 1}^{m} {α}_{i} ( x ; λ )} p ( λ ) . \qquad [ Formula 9 ]$$

wherein p (λ) is the probability distribution reflecting the prior demand for λ, and L is the acquired label data. Thus, the larger the data volume, the greater the likelihood based on the estimated probability of the parameter λ will be.

The parameter λ is determined so that the value of the following Formula becomes large and is determined so that the probability distribution p(λ) becomes large in the case of small data volume.

$${\prod }_{l ∈ L} \frac{{α}_{l} ( x ; λ ) ,}{{\sum }_{i = 1}^{m} {α}_{i} ( x ; λ )}$$

From α₁ (x; λ), the probability distribution for each initial position of the labeled request evaluation value is estimated as follows, and its degree of confidence is calculated (S13). The estimated probability for each initial position is given by the following Formula:

$$\hat{p} ( l \vert x ) = \frac{{α}_{l} ( x ; λ ) ,}{{\sum }_{i} {α}_{i} ( x ; λ ) ,} \qquad [ Formula 10 ]$$

The estimated probability for each initial position is the ratio of the number of pseudo-counts.

The estimated degree of confidence for each initial position is given by the following Formula:

$$u ( x ) = {\sum }_{i} {α}_{i} ( x ; λ ) , \qquad [ Formula 11 ]$$

The estimated degree of confidence is the sum of the pseudo-counts of all labels, and the larger the value, the higher the degree of confidence in the estimated probability.

It should be noted that in addition to the above, the median of the Dirichlet distribution of the following formula and Bayes credible interval or variance of the same Dirichlet distribution may be used as the index of uncertainty for the estimated probability.

$$Dir ( p ( \cdot \vert x ) \vert {( {α}_{l} ( x ; λ ) )}_{l} )$$

### OTHER EMBODIMENTS

This method was applied to the path planning of the robot in the output labeling unit 102 described above, but it is not limited thereto and the method can be applied to various cases as long as the input can be labeled. For example, the evaluation data at the time of high-speed merging of the automated driving system at each initial position or accident occurrence data on the geographical space may be used. Also, the input data is not limited to the initial position and may be any parameter. For example, the parameters such as the start time of the robot, the initial speed, and the placement and dynamics of the obstacles in the environment may be used. Table 1 shows, by way of example, application examples and combinations of inputs and outputs.

TABLE 1

| | | | Prediction of |
|---|---|---|---|
| | | Evaluation of | occurrence of |
| | | high-speed | accident in town |
| | | merging of | for each |
| | Evaluation of | automated | environmental |
| | Robot Path plan | driving | condition |
| Input | Initial position, | Initial position, | Location of |
| | initial speed, | initial speed, | obstacles, |
| | place obstacles, | place obstacles, | location and |
| | dynamics of | dynamics of | speed of mobile |
| | other robots | vehicles | object, |
| | | | weather |
| | | | information |
| Output | Evaluation value | Evaluation value | Accident |
| | of generated | of merging | occurrence spot |
| | route | (smoothness, | |
| | | success/failure | |
| | | etc.) | |

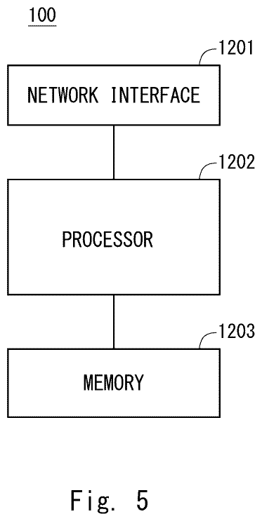

FIG. 5 is a block diagram showing an example a hardware configuration of a computation system. Referring to FIG. 5, the computation system 100 includes a network interface 1201, a processor 1202, and a memory 1203. The network interface 1201 is used to communicate with other network node devices configuring the communication system. The network interface 1201 may be used for wireless communication. For example, the network interface 1201 may be used for wireless LAN communication as defined in the IEEE 802.11 series or mobile communication as defined in the 3rd Generation Partnership Project (3GPP). Alternatively, the network interface 1201 may include, for example, a network interface card (NIC) according to the IEEE 802.3 series.

The processor 1202 reads and executes software (computer programs) from the memory 1203 to perform the processing of the computation system 100 described in the above embodiments using a flowchart or sequence. The processor 1202 of the processor 1202 may include, for example, a CPU (Central Processing Unit), GPU (Graphic Processing Unit), DSP (Digital Signal Processor), MPU (Micro Processing Unit), FPU (Floating point number Processing Unit), PPU (Physics Processing Unit), TPU (Tensor Processing Unit), quantum processor, microcontroller, or a combination thereof.

The memory 1203 may be configured of a combination of a volatile memory and a non-volatile memory. The memory 1203 may include storage installed separately from the processor 1202. In this case, the processor 1202 may access the memory 1203 through an I/O interface (not shown).

In the example of FIG. 5, the memory 1203 is used to store the software modules. The processor 1202 reads these software modules from the memory 1203 and executes them to perform the processing of the computation system 100 described in the above embodiment.

As described with reference to FIG. 5, each of the processors in the computation system 100 executes one or more programs including a group of instructions for causing the computer to perform the algorithm described with reference to the drawings.

The program includes instructions (or software code) for causing the computer to perform one or more functions described in example embodiment when read into the computer. The program may be stored in a non-transitory computer-readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been described with reference to the embodiments, it should be noted that the present disclosure is not limited to the above embodiments. The configuration and details of the present disclosure may be changed in various ways within the scope of the present disclosure that is understandable by those skilled in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A computation system for calculating a probability distribution of an output of control for each input condition in control of an object, wherein
calculation of the probability distribution of the output of the control is performed by calculating certainty of probability for each probability distribution interval and correcting the probability for each interval according to a degree of certainty of the probability.

2. The computation system according to claim 1, wherein in the correction, the probability distribution of the control output is calculated by correcting the probability for each interval so that a probability reduction rate when the certainty of probability is less than a predetermined value is larger than a probability reduction rate when the certainty of probability is higher than a predetermined value.

3. The computation system according to claim 1, wherein the probability distribution of the control output is calculated by correcting a count number of the control for each control input condition according to certainty of the probability and correcting the probability for each interval according to the amount of the corrected count number.

4. The computation system according to claim 1, comprising:
at least one memory storing instructions, and
at least one processor configured to execute the instructions to;
acquire a data set including an input and an output;
discretely label an output of a continuous value;
perform modeling and learning by non-parametric Bayes of the pseudo-count of the labeled output at any input of the data set and calculate the pseudo-count with a predetermined parameter related to the pseudo-count;
calculate the probability distribution of the output labeled from the pseudo-count at any input by Bayesian inference; and
calculate a degree of confidence in the calculation of the probability distribution.

5. The computation system according to claim 4, wherein the output is an output trajectory of a robot system, and the at least one processor is configured to label the output by using evaluation values by time-series clustering or STL (Signal Temporal Logic).
